(19) United States
(12) Patent Application Publication
(10) Pub. No.: US 2004/0034634 A1
(43) Pub. Date: Feb. 19, 2004

(54) Data matching management device matching data created for each hierarchy

(75) Inventor: Kenichi Ichihara, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/340,728

(22) Filed: Jan. 13, 2003

(30) Foreign Application Priority Data
Jul. 25, 2002 (JP) 2002-216400(P)

(51) Int. Cl. G06F 7/00

(52) U.S. Cl. 707/6

(57) ABSTRACT

When a hierarchy for which matching is performed is higher than a reference hierarchy, a matching portion sets the sum of values set in the reference hierarchy for a value in the hierarchy for which matching is performed. When the hierarchy for which matching is performed is lower than the reference hierarchy, the matching portion distributes the value set in the reference hierarchy in proportion of the values set in the hierarchy for which matching is performed. Therefore, data match is achieved through all hierarchies, and the data can be managed in a centralized manner.

### BACKGROUND OF THE INVENTION

1. Field of the Invention

The present invention relates to a technique managing data created for each hierarchy, and more particularly to a data matching management device achieving data matching for each hierarchy and implementing centralized management.

2. Description of the Background Art

Recently, as processing speed of a computer has remarkably improved, data processing requiring a large amount of operation has been carried out in high speed, and a variety of application programs have been developed. As one example, there is an application program processing data created for a plurality of hierarchies.

In a conventional data processing program, however, the data created for each hierarchy is operated independently of one another, and there has been no such program as achieving data match among hierarchies and concurrently managing the data in a centralized manner. Therefore, the data have not been matched among hierarchies, and have been inconsistent.

For example, when a sales target for the whole company is set, there has been no means to match the figure of sales target for the whole company to those for each branch, department and section of lower levels. Accordingly, in order to achieve precise match, it has been necessary to adjust the respective target figures among hierarchies or within a hierarchy to correct the data. Consequently, as the number of hierarchies increases, an operation for data correction has been complicated.

### SUMMARY OF THE INVENTION

An object of the present invention is to provide a data matching management device achieving data match through all hierarchies and implementing centralized data management.

Another object of the present invention is to provide a data matching management device capable of readily obtaining data which is matched based on any hierarchy.

According to one aspect of the present invention, a data matching management device performs matching with respect to data created for a plurality of hierarchies. The data matching management device includes a determination portion determining whether or not a hierarchy for which matching is performed is higher than a reference hierarchy, and a matching portion matching data in the reference hierarchy to that in the hierarchy for which matching is performed, in accordance with a determination result by the determination portion.

As the matching portion matches the data in the reference hierarchy to that in the hierarchy for which matching is performed in accordance with the determination result by the determination portion, data match can be achieved through all hierarchies, and the data can be managed in a centralized manner.

According to another aspect of the present invention, a data matching management device performs matching with respect to data created for a plurality of hierarchies. The data matching management device includes a specifying portion specifying a hierarchy of which value is to be utilized in matching, a multiplexing portion duplicating and multiplexing the data created for each hierarchy in accordance with the hierarchy specified by the specifying portion, a determination portion determining whether or not a hierarchy for which matching is performed is higher than that specified by the specifying portion, and a matching portion matching multiplexed data by the multiplexing portion, in accordance with a determination result by the determination portion.

As the matching portion matches the data multiplexed by the multiplexing portion in accordance with the determination result by the determination portion, the data which is matched based on any hierarchy can readily be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a hierarchical configuration of data processed by a data matching management device in a first embodiment of the present invention.

FIG. 2 shows an example of data created for each hierarchy.

FIG. 3 illustrates data matching by the data matching management device in the first embodiment of the present invention.

FIG. 4 shows an example in which the sum of values set in a lower hierarchy does not exceed a value set in a higher hierarchy.

FIG. 5 shows an example in which data in each hierarchy shown in FIG. 4 are matched.

FIG. 6 is a block diagram showing an example of a configuration of the data matching management device in the first embodiment of the present invention.

FIG. 7 is a block diagram showing a functional configuration of the data matching management device in the first embodiment of the present invention.

FIG. 8 is a flowchart illustrating a processing procedure of the data matching management device in the first embodiment of the present invention.

FIG. 9 is a block diagram showing a functional configuration of a data matching management device in a second embodiment of the present invention.

FIG. 10 illustrates multiplexing of a data configuration.

FIG. 11 illustrates matching of the multiplexed data.

### DESCRIPTION OF THE PREFERRED EMBODIMENTS

(First Embodiment)

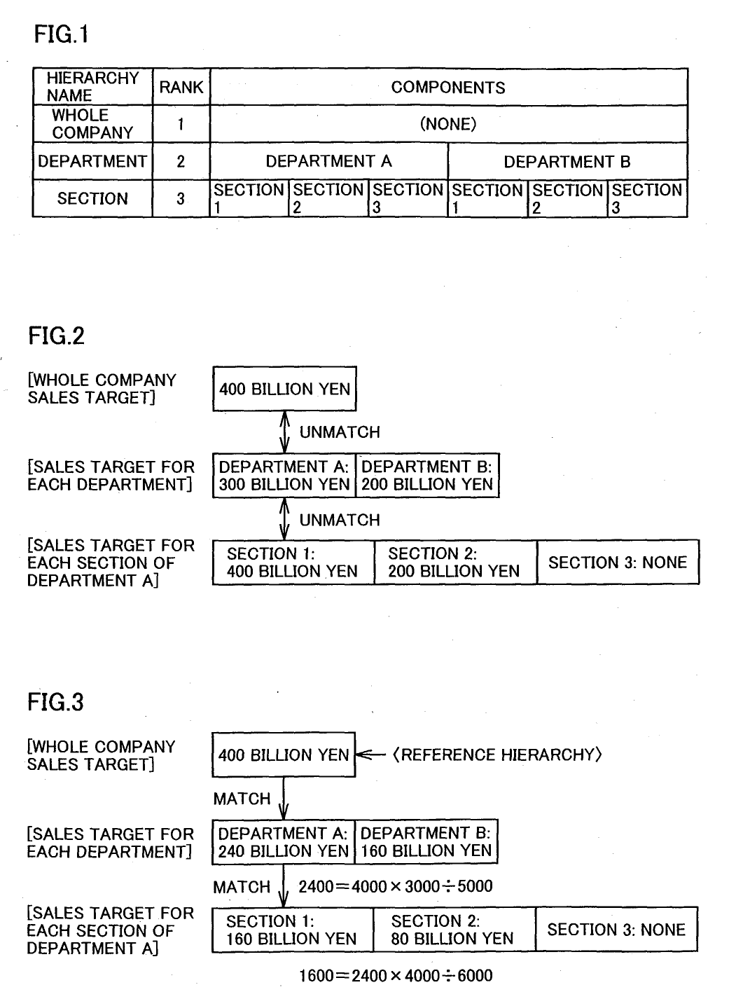

FIG. 1 illustrates a hierarchical configuration of data processed by a data matching management device in a first embodiment of the present embodiment. Each hierarchy is given a hierarchy name, and a “rank” and a “component” are also provided therein. As shown in FIG. 1, three hierarchies are provided. That is, there are three hierarchy names of “whole company”, “department” and “section”, and ranks “1” to “3” representing higher/lower hierarchy are provided for respective hierarchies.

In addition, components are contained in each hierarchy. A hierarchy “whole company” has no component. A hierarchy “Department” includes two components of “Department A” and “Department B”. Further, a hierarchy “section” includes six components of “Section 1”, “Section 2” and “Section 3” corresponding to “Department A” as well as “Section 1”, “Section 2” and “Section 3” corresponding to “Department B”.

FIG. 2 shows an example of data created for each hierarchy. A sales target for the whole company is 400 billion yen, and sales targets for Departments A and B are 300 billion yen and 200 billion yen respectively. Therefore, the sales target for the whole company does not match the sum of sales target figures for each department. In addition, the sales targets for Sections 1, 2 and 3 of Department A are 400 billion yen, 200 billion yen, and none, respectively. Accordingly, the sales target for Department A does not match the sum of the sales targets for each section of Department A.

FIG. 3 illustrates data matching by the data matching management device in the first embodiment of the present invention. The data matching management device determines a reference hierarchy among a plurality of hierarchies, and performs matching with respect to data in a hierarchy lower (or higher) than the reference hierarchy in accordance with a data setting state of the lower (or higher) hierarchy, based on the following rules.

1. When the data is set for all components in the lower hierarchy

A value set in the higher hierarchy is distributed in proportion of values set in the lower hierarchies, and values in the lower hierarchies are set again. For example, when a hierarchy “whole company” shown in FIG. 2 is determined as the reference hierarchy, and an amount of the sales target for the whole company is distributed in proportion of those for Department A and B, which are the components in a lower hierarchy “Department”, the sales targets for Departments A and B are 240 billion yen and 160 billion yen respectively, as shown in FIG. 3. Thus, match is achieved.

2. When the data is not set in some components of lower hierarchies

1) If the sum of the values set in the lower hierarchies exceeds the value set in the higher hierarchy, the value set in the higher hierarchy is distributed in proportion of the values set in the lower hierarchies for setting again the values in the lower hierarchies. For example, when the hierarchy “Department” shown in FIG. 3 is determined as the reference hierarchy, and the amount of sales target for Department A is distributed in proportion of those for Section 1 and 2, which are the components of the lower hierarchy “Section”, the sales targets for Section 1 and 2 are 160 billion yen and 80 billion yen respectively, as shown in FIG. 3. Thus, matching is achieved. Here, Section 3 does not have a value set.

2) When the sum of the values set in the lower hierarchies does not exceed the value set in the higher hierarchy, the values set for the components in the lower hierarchies are left as they are, and a difference between the value set in the higher hierarchy and the sum of the values set in the lower hierarchies is equally allotted to components of which values are not set in the lower hierarchies.

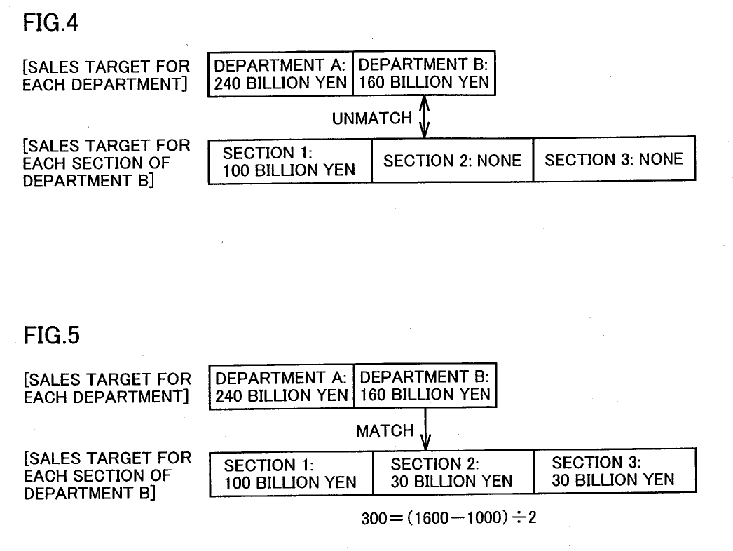

FIG. 4 shows an example in which the sum of the values set in lower hierarchies does not exceed the value set in the higher hierarchy. The sales target for Department B is 160 billion yen, the sales targets for Sections 1, 2 and 3 thereof are 100 billion yen, none, and none, respectively. The sales target for Department B does not match the sum of the sales target values for each department.

FIG. 5 shows an example in which the data of each hierarchy shown in FIG. 4 are matched. Since the sales target for Section 1 is set to 100 billion yen, the difference of 60 billion yen between the sales targets for Department B and Section 1 is equally allotted as the sales targets for Sections 2 and 3.

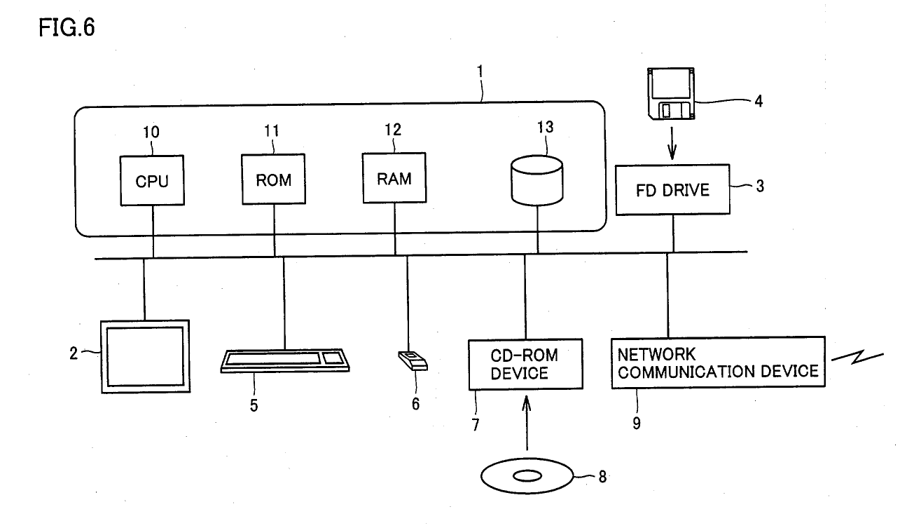

FIG. 6 is a block diagram showing an example of a configuration of the data matching management device in the first embodiment of the present invention. The data matching management device includes a computer body 1, a display 2, a FD drive 3 to which a FD (a Flexible Disk) is mounted, a keyboard 5, a mouse 6, a CD-ROM device 7 to which a CD-ROM (Compact Disc-Read Only Memory) 8 is mounted, and a network communication device 9.

A program implementing the data matching management device (hereinafter, referred to as a “data matching management program”) is supplied by a storage medium such as FD 4, CD-ROM 8 or the like. The data matching management program is executed by computer body 1, and thus data match is managed. The data matching management program may be supplied to computer body 1 via network communication device 9 from another computer.

Computer body 1 includes a CPU (Central Processing Unit) 10, a ROM (Read Only Memory) 11, a RAM (Random Access Memory) 12, and a hard disk 13. CPU 10 inputs/outputs data to/from display 2, FD drive 3, keyboard 5, mouse 6, CD-ROM device 7, network communication device 9, ROM 11, RAM 12 or hard disk 13 for processing. The data matching management program recorded on FD 4 or CD-ROM 8 is once stored in hard disk 13 via FD drive 3 or CD-ROM device 7 by CPU 10. CPU 10 loads the data matching management program from hard disk 13 to RAM 12 for execution as required, and data match is thus managed.

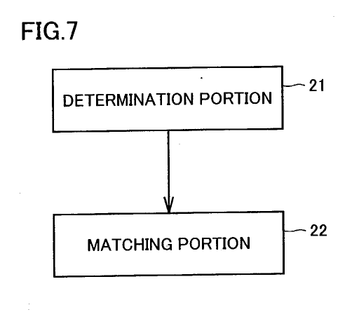

FIG. 7 is a block diagram showing a functional configuration of the data matching management device in the first embodiment of the present invention. The data matching management device includes a determination portion 21 determining whether or not the hierarchy for which matching is performed is higher than the reference hierarchy, and a matching portion 22 matching data in the reference hierarchy to data in the hierarchy for which matching is performed.

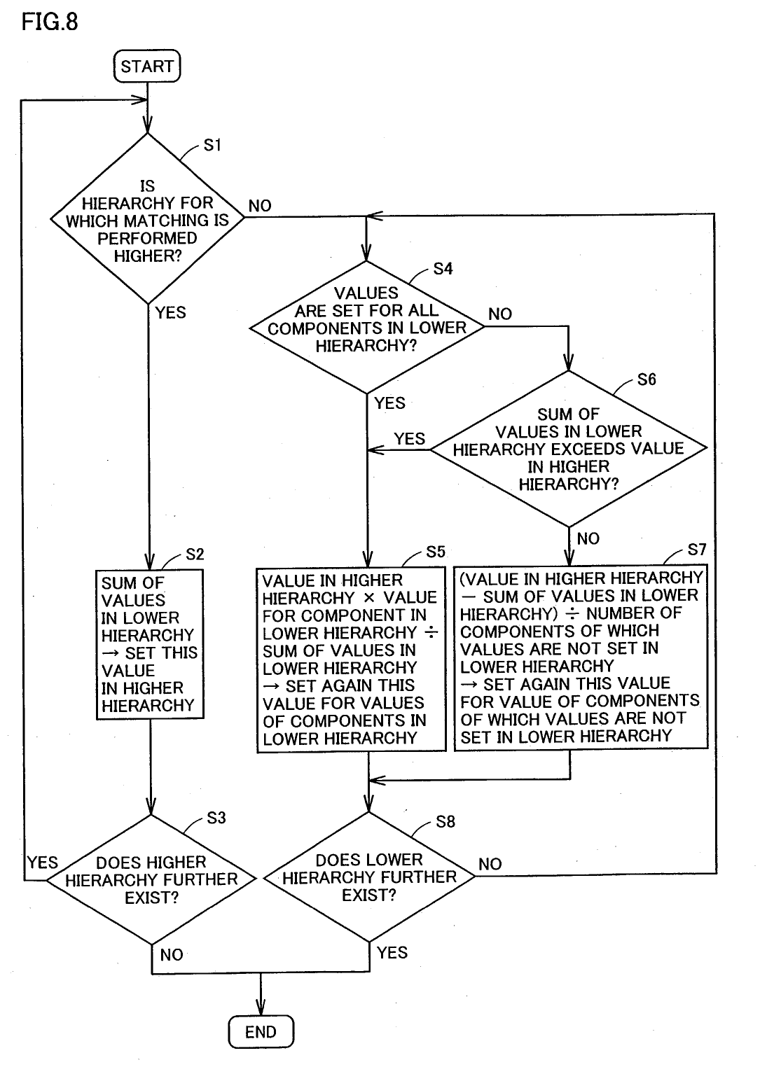

FIG. 8 is a flowchart illustrating a processing procedure of the data matching management device in the first embodiment of the present invention. First, determination portion 21 determines whether the hierarchy for which matching is performed is high or low out of two target hierarchies (S1). If the hierarchy for which matching is performed is higher (S1, Yes), matching portion 22 sets the sum of the values set in the lower hierarchy for the higher hierarchy (S2), and determines whether or not a higher hierarchy further exists (S3). If a higher hierarchy further exists (S3, Yes), the process returns to step S1, and subsequent steps are repeated. If a higher hierarchy does not exist (S3, No), the process ends.

If the hierarchy for which matching is performed is the lower hierarchy (S1, No), matching portion 22 determines whether or not the values are set for all components in the lower hierarchy (S4). If the values are set for all components in the lower hierarchy (S4, Yes), matching portion 22 calculates “the value in the higher hierarchy ×the value for the component in the lower hierarchy ÷the sum of the values in the lower hierarchy” for setting again that value for the value of the component in the lower hierarchy (S5). Then, the process will proceed to step S8.

In addition, if there are some components in the lower hierarchy of which values are not set (S4, No), matching portion 22 determines whether or not the sum of the values in the lower hierarchy exceeds the value in the higher hierarchy (S6). If the sum of the values in the lower hierarchy exceeds the value in the higher hierarchy (S6, Yes), matching portion 22 calculates “the value in the higher hierarchy ×the value for the component in the lower hierarchy ÷the sum of the values in the lower hierarchy” for setting again that value for the value of the component in the lower hierarchy (S5). Then, the process will proceed to step S8.

If the sum of the values in the lower hierarchy does not exceed the value in the higher hierarchy (S6, No), matching portion 22 calculates “(the value in the higher hierarchy −the sum of the values in the lower hierarchy) ÷the number of components of which values are not set in the lower hierarchy” for setting again that value for the components of which values are not set in the lower hierarchy. Then, the process will proceed to step S8.

In step S8, matching portion 22 determines whether or not a lower hierarchy further exists. If a lower hierarchy further exists (S8, Yes), the process returns to step S4, and subsequent steps are repeated. If a further lower hierarchy does not exist (S8, No), the process ends.

As described above, according to the data matching management device in the present embodiment, when the data do not match among hierarchies, any hierarchy may be determined as a reference hierarchy, and a value in another hierarchy is adjusted based on the values in the reference hierarchy. Therefore, data match can be achieved through all hierarchies, and the data can be managed in a centralized manner.

(Second Embodiment)

The data matching management device in the first embodiment of the present invention determines whether or not the hierarchy for which matching is performed is the higher hierarchy, and performs data matching in accordance with the determination result. A data matching management device in a second embodiment of the present invention specifies a hierarchy of which value is to be utilized in data matching (hereinafter, referred to as a “base hierarchy”), multiplexes a data configuration by the number of base hierarchies, and then performs data matching. Note that a configuration example of the data matching management device in the second embodiment is similar to that in the first embodiment shown in FIG. 6. In addition, a method of data matching is similar to that illustrated in the flowchart shown in FIG. 7. Therefore, detailed description of an overlapping configuration, function, and processing procedure will not be repeated.

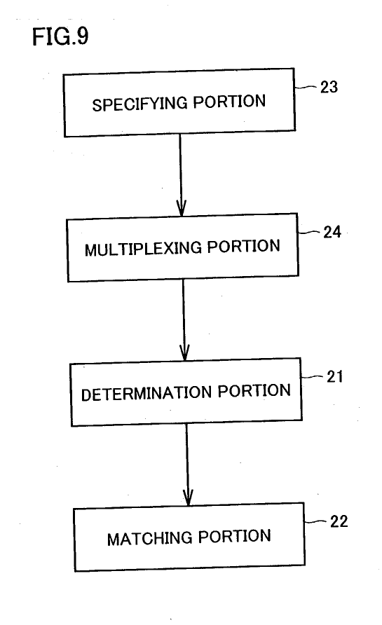

FIG. 9 is a block diagram showing a functional configuration of the data matching management device in the second embodiment of the present invention. The data matching management device includes a specifying portion 23 specifying a hierarchy of which value is to be utilized in data matching, a multiplexing portion 24 duplicating and multiplexing data created for each hierarchy in accordance with the hierarchy specified by specifying portion 23, a determination portion 21 determining whether or not the hierarchy for which matching is performed is higher than the hierarchy specified by specifying portion 23, and a matching portion 22 matching the data in a reference hierarchy to the data in the hierarchy for which matching is performed.

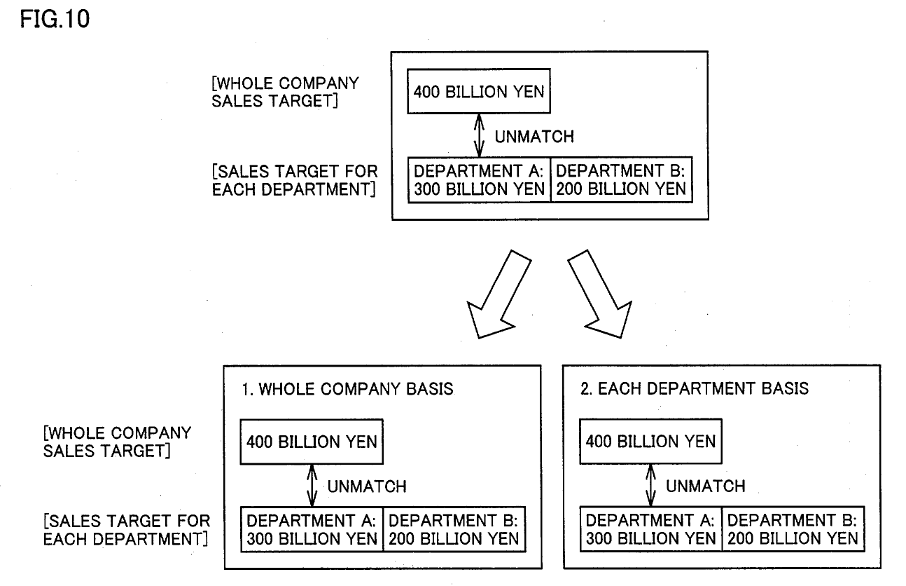

FIG. 10 illustrates multiplexing of the data configuration. When the hierarchy “whole company” and the hierarchy “department” are specified as base hierarchies by specifying portion 23, multiplexing portion 24 duplicates and multiplexes the data into data utilizing the value in the hierarchy “whole company” (1. whole company basis) and data utilizing the value in the hierarchy “department” (2. each department basis).

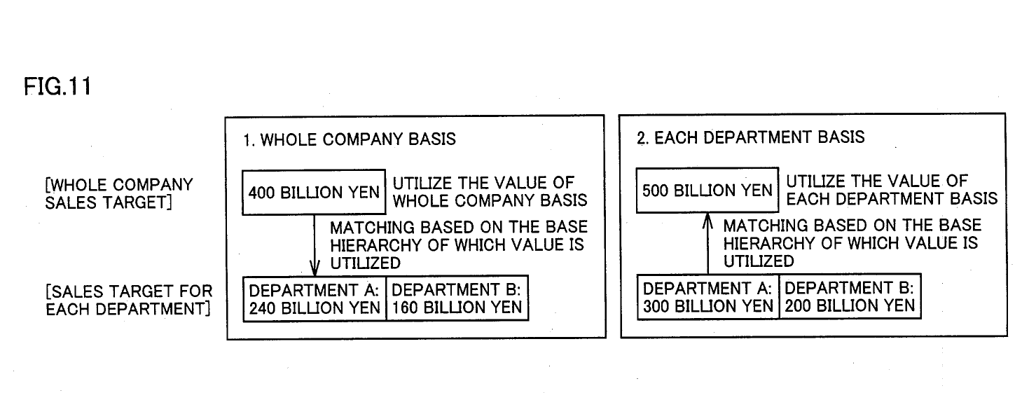

FIG. 11 illustrates matching of the data multiplexed by multiplexing portion 24. For the data utilizing the value in hierarchy “whole company” (1. whole company basis), specifying portion 23 determines the hierarchy “whole company” as the reference hierarchy, and matching portion 22 performs matching with respect to data in the hierarchy “department”, and holds that data. Meanwhile, for the data utilizing the value in hierarchy “department” (2. each department basis), specifying portion 23 determines the hierarchy “department” as the reference hierarchy, and matching portion 22 performs matching with respect to data in the hierarchy “whole company”, and holds that data.

If the value based on the whole company is needed, the matched data (1) is adopted for use. If the value based on each department is needed, the matched data (2) is adopted for use.

Note that, when the data is multiplexed, the degree of multiplexing may arbitrarily be set in accordance with the number of base hierarchies.

As described above, according to the data matching management device in the present embodiment, specifying portion 23 specifies a hierarchy of which value is to be utilized, and multiplexing portion 24 accordingly multiplexes the data. Therefore, data which is matched based on any hierarchy can readily be obtained, and usability can be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data matching management device performing matching with respect to data created for a plurality of hierarchies, comprising:
a determination portion determining whether or not a hierarchy for which matching is performed is higher than a reference hierarchy; and
a matching portion matching data in said reference hierarchy to data in the hierarchy for which said matching is performed, in accordance with a determination result by said determination portion.

2. The data matching management device according to claim 1, wherein
when the hierarchy for which said matching is performed is higher than said reference hierarchy, said matching portion performs matching by setting a sum of values set in said reference hierarchy for a value in the hierarchy for which said matching is performed.

3. The data matching management device according to claim 1, wherein
when the hierarchy for which said matching is performed is lower than said reference hierarchy, said matching portion performs matching by distributing a value set in said reference hierarchy in proportion of values set in the hierarchy for which said matching is performed.

4. A data matching management device performing matching with respect to data created for a plurality of hierarchies, comprising:
a specifying portion specifying a hierarchy of which value is to be utilized in matching;
a multiplexing portion duplicating and multiplexing the data created for each hierarchy, in accordance with the hierarchy specified by said specifying portion;
a determination portion determining whether or not a hierarchy for which matching is performed is higher than the hierarchy specified by said specifying portion; and
a matching portion matching data multiplexed by said multiplexing portion in accordance with a determination result by said determination portion.
